(19) United States
(12) Patent Application Publication
(10) Pub. No.: US 2013/0161536 A1
(43) Pub. Date: Jun. 27, 2013

(54) MICROORGANISM DETECTING APPARATUS CALIBRATION METHOD AND MICROORGANISM DETECTING APPARATUS CALIBRATION KIT

(71) Applicant: Azbil Corporation, Tokyo (JP)

(72) Inventor: Norio Hasegawa, Tokyo (JP)

(73) Assignee: AZBIL CORPORATION, Tokyo (JP)

(21) Appl. No.: 13/719,941

(22) Filed: Dec. 19, 2012

(30) Foreign Application Priority Data
Dec. 21, 2011 (JP) 2011-279789
Sep. 14, 2012 (JP) 2012-202283

(51) Int. Cl. G01N 21/64

(52) U.S. Cl. CPC G01N 21/64
USPC 250/459.1; 526/346; 526/347.1; 428/402; 250/216

(57) ABSTRACT

A method for calibrating a microorganism detecting apparatus including drawing, into a microorganism detecting apparatus, polystyrene particles that, when exposed to light produce fluorescence of essentially the same intensity as the intensity of fluorescence produced by microorganisms; exposing the polystyrene particles to light from a light source of the microorganism detecting apparatus and detecting, using a fluorescence detector of the microorganism detecting apparatus, the fluorescence produced from the polystyrene particles; and calibrating the microorganism detecting apparatus based on the intensity of the detected fluorescence.

### CROSS-REFERENCE TO RELATED APPLICATIONS

The present application claims priority to Japanese Applications 2011-279789 and 2012-202283 filed Dec. 21, 2011 and Sep. 14, 2012, respectively. Both applications are incorporated by reference in their entirety.

### FIELD OF TECHNOLOGY

The present invention relates to an environment evaluating technology, and, in particular, relates to a microorganism detecting apparatus calibration method and microorganism detecting apparatus calibration kit.

### BACKGROUND

In clean rooms in, for example, pharmaceutical product manufacturing factories, the quantity of microorganisms suspended within the air in the room is monitored using a microorganism detecting apparatus. When evaluating the performance of the microorganism detecting apparatus, or calibrating the accuracy thereof, known microorganisms are drawn into the microorganism detecting apparatus to evaluate the output of the microorganism detecting apparatus. (See, for example, Japanese Unexamined Patent Application Publication 2004-159508, Japanese Unexamined Patent Application Publication 2008-22764, and Japanese Unexamined Patent Application Publication 2008-22765.)

However, microorganisms that are used when evaluating the microorganism detecting apparatus have the potential to contaminate the environment such as the clean room, the chamber, or the like. Given this, one of the objects of the present invention is to provide a calibrating method for a microorganism detecting apparatus, and a calibrating kit for the microorganism detecting apparatus, that do not use microorganisms.

### SUMMARY

An example of the present invention provides a microorganism detecting apparatus calibrating method that includes: (a) drawing into the microorganism detecting apparatus polystyrene particles that, when exposed to light, produce fluorescence of essentially identical intensity to the intensity of fluorescence produced by microorganisms; (b) exposing the polystyrene particles to light from a source of the microorganism detecting apparatus and detecting, using a fluorescence detector of the microorganism detecting apparatus, the fluorescence produced from the polystyrene particles; and (c) calibrating the microorganism detecting apparatus based on the intensity of the detected fluorescence.

Moreover, an example according to the present invention provides a microorganism detecting apparatus calibrating kit comprising polystyrene particles that, when exposed to light, produce fluorescence of essentially the identical intensity to the intensity of the fluorescence that is produced by microparticles.

The present invention enables the provision of a microorganism detecting apparatus calibrating method, and a microorganism detecting apparatus calibrating kit, that do not use microorganisms.

### BRIEF DESCRIPTIONS OF THE DRAWINGS

FIG. 1 is a schematic diagram of a test chamber according to an example of the present invention.

FIG. 2 is a schematic cross-sectional diagram of a microorganism detecting apparatus according to an example of the present invention.

FIG. 3 is a graph showing the distributions of fluorescence intensities for polystyrene particles and microorganisms observed under a fluorescent microscope, under dry conditions, in an example according to the present invention.

FIG. 4 is a graph showing the distributions of fluorescence intensities for polystyrene particles and microorganisms observed under a fluorescent microscope, under dry conditions, in an example according to the present invention.

FIG. 5 is a graph showing the distributions of fluorescence intensities for polystyrene particles and microorganisms observed under a fluorescent microscope, under dry conditions, in an example according to the present invention.

FIG. 6 is a graph showing the 95% confidence intervals for fluorescence intensities for polystyrene particles observed under a fluorescent microscope, under dry conditions, in an example according to the present invention.

FIG. 7 is a graph showing the fluorescence intensities for polystyrene particles and microorganisms observed under a fluorescent microscope, in an example according to the present invention.

FIG. 8 is a graph showing the distributions for fluorescence intensities for polystyrene particles observed under a fluorescent microscope, under in-fluid conditions, in an example according to the present invention.

FIG. 9 is a graph showing the 95% confidence intervals for fluorescence intensities for polystyrene particles observed under a fluorescent microscope, under in-fluid conditions, in an example according to the present invention.

FIG. 10 is a graph showing the fluorescence intensities for polystyrene particles and microorganisms detected by an airborne microbe detector, in an example according to the present invention.

### DETAILED DESCRIPTION

An example of the present invention is described below. In the descriptions of the drawings below identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

The method for calibrating a microorganism detecting apparatus according to an example includes drawing, into the microorganism detecting apparatus, polystyrene particles that, when exposed to light, produce fluorescence of essentially the same intensity as the intensity of fluorescence produced by microorganisms; exposing the polystyrene particles to light from a light source of the microorganism detecting apparatus and detecting, using a fluorescence detector of the microorganism detecting apparatus, the fluorescence produced from the polystyrene particles; and calibrating the microorganism detecting apparatus based on the intensity of the detected fluorescence.

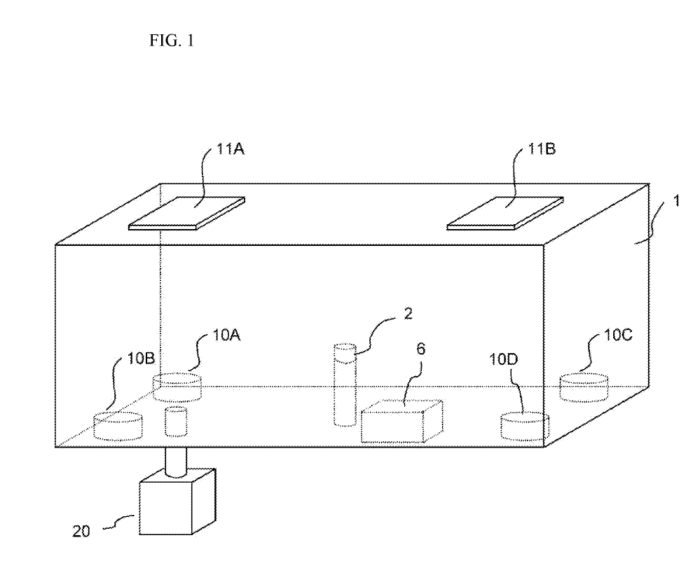

As illustrated in FIG. 1, a microorganism detecting apparatus 20 that is the subject of the calibration method is disposed in, for example, a test chamber 1. The test chamber 1 is a chamber that is provided with, for example, an aluminum frame and transparent panels, made from polycarbonate, fitted into the frame to serve as side walls. Air supplying devices 11A and 11B, for example, are provided in the test chamber 1. The air supplying devices 11A and 11B supply, into the test chamber 1, clean air through ultrahigh performance air filters such as HEPA filters (High Efficiency Particulate Filters) or ULPA filters (Ultra Low Penetration Air Filters), or the like. A door may be provided in a side wall of the test chamber 1.

The polystyrene particles according to the example are discharged into the interior of the test chamber 1 from a spraying device 2 that is equipped in the test chamber 1. The spraying device 2 is, for example, a jet-type nebulizer, and holds a fluid that includes polystyrene particles at a prescribed concentration. In the spraying device 2, a gas flow, such as of a compressed gas, is provided with a prescribed flow rate, where the gas flow blows into the fluid that includes the polystyrene particles to produce an aerosol, to spray in the form of a mist, into the interior of the test chamber, the fluid that includes the polystyrene particles. Note that while in the FIG. 1 the spraying device 2 is disposed within the test chamber 1, the spraying device 2 may instead be disposed on the outside of the test chamber 1, with the aerosol that is sprayed by the spraying device 2 directed into the test chamber 1 through ducting, or the like.

Agitating fans 10A, 10B, 10C, and 10D are disposed as agitating devices within the test chamber 1. The agitating fans 10A through 10D agitate the air within the test chamber 1, to prevent natural settling, by their own weight, of the polystyrene particles that are dispersed into the air within the test chamber 1.

Moreover, an air cleaner 6, as a cleaning device, is disposed within the test chamber 1. The air cleaner 6 removes particles that are included in the gas, such as air, or the like, within the test chamber 1, to clean the gas. For example, prior to spraying the fluid that contains the polystyrene particles into the test chamber 1 from the spraying device 2, the air cleaner 6 can be run to remove in advance, from within the test chamber 1, any microparticles or microorganisms other than the polystyrene particles that are to be sprayed from the spraying device 2. Note that while in FIG. 1 the air cleaner 6 is disposed on the bottom surface within the test chamber 1, the air cleaner 6 may instead be disposed on a wall or the ceiling of the test chamber 1.

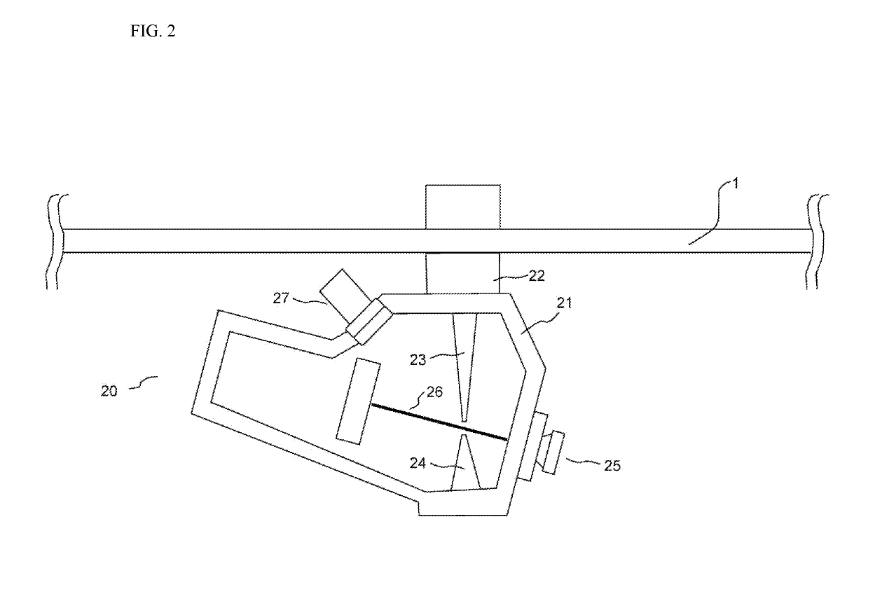

As illustrated in the schematic cross-sectional diagram in FIG. 2, for example, the microorganism detecting apparatus 20 is provided with a frame 21 and a first vacuum device 22 drawing dry air from within the test chamber 1 into the interior of the frame 21. The air drawn in by the first vacuum device 22 is expelled from the tip of a nozzle 23 within the frame 21. The air that is expelled from the tip of the nozzle 23 is drawn in by a second vacuum 24, disposed within the frame 21, facing the tip of the nozzle 23. The microorganism detecting apparatus 20 is provided further with a light source 25, such as a laser. The light source 25 directs a laser beam 26 toward the air that is drawn by the second vacuum device 24. The laser beam 26 may be of visible light, or may be of ultraviolet radiation. If the laser beam 26 is of visible light, then the wavelength of the laser beam 26 is within a range of, for example, between 400 and 410 nm, for example, 405 nm. If the laser beam 26 is of ultraviolet radiation, then the wavelength of the laser beam 26 is in a range of, for example, between 310 and 380 nm, for example, 340 nm.

When microorganisms, such as microbes, or the like existing within the air, are exposed to the laser beam 26, they produce fluorescence. Examples of such microbes include Gram-negative bacteria, Gram-positive bacteria, and fungi such as mold spores. Escherichia coli, for example, can be listed as an example of a Gram-negative bacterium. Staphylococcus epidermidis, Bacillus atrophaeus, Micrococcus lylae, and Corynebacterium afermentans can be listed as examples of Gram-positive bacteria. Aspergillus niger can be listed as an example of a fungus such as a mold spore. The microorganism detecting apparatus 20 is further equipped with a fluorescence detector 27. The fluorescence detector 27 detects the fluorescence produced by the microorganisms and measures the intensity of the fluorescence. The microorganism detecting apparatus 20, based on the magnitude of the fluorescence intensity, is able to measure the concentration of the microorganisms that exist in the air.

When calibrating the microorganism detecting apparatus 20, preferably all dust, dirt, microparticles, microorganisms, and the like are completely removed from within the test chamber 1, illustrated in FIG. 1, by the air cleaner 6, and polystyrene particles are discharged from the spraying device 2. The air that includes the polystyrene particles that have been discharged is drawn into the microorganism detecting apparatus 20, to be illuminated by the laser beam 26 shown in FIG. 2. While typically polystyrene particles are not categorized as fluorescent materials, the polystyrene particles that have been exposed to the laser beam 26 produce intrinsic fluorescence. Because of this, it is possible to calibrate the sensitivity, and the like, of the fluorescence detector 27 of the microorganism detecting apparatus 20 using polystyrene particles instead of using microorganisms.

The intensity of the fluorescence produced by the polystyrene particles will vary depending on the material of the polystyrene particle and on the particle size. Consequently, polystyrene particles of each of multiple different materials and different sizes may each be drawn into the microorganism detecting apparatus 20, to evaluate whether or not the fluorescence detector 27 of the microorganism detecting apparatus 20 has sensitivity able to discern the differences in the respective fluorescence intensities of the polystyrene particles with the respectively different materials and sizes.

Polystyrene particles are made from, for example, polystyrene. Alternatively, the polystyrene particles may be made from polystyrene plus additives. Additionally, the polystyrene particles may be made instead from, for example, 98% by mass polystyrene and 2% by mass divinylbenzene.

Essentially, the diameters of the polystyrene particles made from polystyrene preferably are no less than 0.75 μm up to 10 μm, and more preferably, no less than 0.75 μm up to 5 μm. If the particle size of the polystyrene particle made from polystyrene were to be less than 0.75 μm, then the intensity of fluorescence produced by a single polystyrene particle would tend to be weaker than the intensity of the fluorescence produced by a single microorganism. Moreover, if the particle size of the polystyrene particle made from polystyrene were to be about 10 μm or more, then the intensity of the fluorescence produced by a single polystyrene particle would tend to be greater than the intensity of fluorescence produced by a single microorganism. There is essentially no limitation to the range set forth above insofar as the size of the polystyrene particles made from polystyrene is selected so that the intensity of the fluorescence produced when a polystyrene particle is exposed to light is nearly identical to the intensity of the fluorescence produced by a microorganism.

The diameters of the polystyrene particles made from polystyrene preferably and divinylbenzene can be no less than 0.75 μm up to 7.5 μm. If the particle size of the polystyrene particle made from polystyrene and divinylbenzene were to be less than about 0.75 μm, then the intensity of fluorescence produced by a single polystyrene particle would tend to be weaker than the intensity of the fluorescence produced by a single microorganism. Moreover, if the particle size of the polystyrene particle made from polystyrene and divinylbenzene were to be more than 7.5 μm, then the intensity of fluorescence produced by a single polystyrene particle would tend to be greater than the intensity of the fluorescence produced by a single microorganism. There is almost no limitation to the range set forth above insofar as the size of the polystyrene particles made from polystyrene and divinylbenzene is selected so that the intensity of the fluorescence produced when a polystyrene particle is exposed to light is nearly identical to the intensity of the fluorescence produced by a microorganism.

Conventionally, when calibrating a microorganism detecting apparatus, microorganisms of a known concentration are drawn into the microorganism detecting apparatus and calibration is performed so that the microorganism concentration calculated by the microorganism detecting apparatus, compared to the actual microorganism concentration will be equal. However, because microorganisms require culturing facilities and safety equipment for preventing leakage, there is a problem in that the calibration of the microorganism detecting apparatus is quite costly. In contrast, the use of polystyrene particles in calibrating the microorganism detecting apparatus eliminates the need for culturing facilities and for safety equipment, thus making it possible to reduce substantially the cost involved in calibration of the microorganism detecting apparatus.

Furthermore, the fluorescence produced by the microorganism will vary depending on the conditions of growth for the microorganisms, as described in Applied Microbiology and Biotechnology, Vol. 30, 59-66 and The Chemical Engineering Journal, Vol. 34, B7-B12. Because of this, even when performing calibration of a microorganism detecting apparatus using microorganisms, still it may not be possible to obtain indicators for setting the target value (threshold value) for sensitivity of the fluorescence detector of the microorganism detecting apparatus. In contrast, because the intensities of the fluorescence produced by the polystyrene particles are stable, use of polystyrene particles in calibrating microorganism detecting apparatuses makes it possible to perform the calibration of the microorganism detecting apparatuses reliably.

### EXAMPLES

While a more specific description is provided below through examples, the present invention is in no way limited by the examples of embodiment set forth below.

### Example 1

Obtaining the Polystyrene Particles

For the polystyrene particles, Thermo Scientific Nanosphere 3000-series size-standard product no. 3500A, Latex Microsphere Suspensions 5000-series product no. 5100A, and Duke Standards 4000-series Monosized Particles product nos. 4203A and 4205A were obtained from Fisher Scientific.

The particles of product no. 3500A were supplied as a suspension, with a particle size of 498 nm±9 nm (coefficient of variance: 1.6%), where the material was polystyrene with a density of 1.05 g/cm³, and an index of refraction of 1.59. The product no. 3500A particles had particle size uniformity adequate to enable their use as a reference sample for a 0.5 μm particle size.

The particles of product no. 5100A were supplied as a suspension, with a particle size of 1.0 μm (coefficient of variance: no more than 3%), where the material was polystyrene with a density of 1.05 g/cm³, and an index of refraction of 1.59.

The particles of product no. 4203A were supplied as a suspension, with a particle size of 3.002 μm±0019 (coefficient of variance: 1.1%), where the material was polystyrene. The product no. 4203A particles had particle size uniformity adequate to enable their use as a reference sample for a 3 μm particle size.

The particles of product no. 4205A were supplied as a suspension, with a particle size of 4.993 μm±0040 (coefficient of variance: 1.0%), where the material was polystyrene. The product no. 4205A particles had particle size uniformity adequate to enable their use as a reference sample for a 5 μm particle size.

Moreover, Polymer Microspheres-series product no. PS04N/5749, product no. PS06N/5623, and product no. PS05N/7508 were obtained from Bangs Laboratories.

The particles of product no. PS04N/5749 were supplied as a suspension, with a particle size of 1.01 μm, where the material was polystyrene with a density of 1.05 g/cm³.

The particles of product no. PS06N/5623 were supplied as a suspension, with a particle size of 5.09 μm (coefficient of variance: 0.44 μm), where the material was cross-linked poly (styrene/2% divinylbenzene) with a density of 1.062 g/cm³. The product no. PS06N/5623 particles had particle size uniformity adequate to enable their use as a reference sample for a 5 μm particle size.

The particles of product no. PS05N/7508 were supplied as a suspension, with a particle size of 4.61 μm (coefficient of variance: 0.63 μm), where the material was polystyrene with a density of 1.05 g/cm³. The product no. PS05N/7508 particles had particle size uniformity adequate to enable their use as a reference sample for a 4.6 μm particle size.

Moreover, DYNOSPHERES™-series product no. SS-053-P and product no. SS-104-P were obtained from JSR Corporation.

The particles of product no. SS-053-P were supplied as a suspension, with an average particle size of 5.124 μm (coefficient of variance: 1.22%), where the material was polystyrene.

The particles of product no. SS-053-P, as standard particles, have a long track record for use in calibration of particle diameter measuring devices and use as dimensional standards.

The particles of product no. SS-104-P were supplied as a suspension, with an average particle size of 10.14 μm (coefficient of variance: 1.20%), where the material was polystyrene. The particles of product no. SS-104-P, as standard particles, have a long track record for use in calibration of particle diameter measuring devices and use as dimensional standards.

Furthermore, the 3.00 μm Microbead NIST Traceable Particle Size Standard (product no. 64060-15) was obtained from Polyscience, Inc. The particles of product no. 64060-15 were supplied as a suspension, with a particle size distribution between 2.85 and 3.15 μm, where the material was polystyrene. The particles of product no. 64060-15, as standard particles, have a long track record for use in calibration of particle diameter measuring devices and use as dimensional standards.

Rinsing the Polystyrene Particles

1 mL of a suspension of one type of a polystyrene particle that was obtained was transferred to a microcentrifuge tube, and placed in a centrifuge (Hitachi Koki, model CT13R) five minutes at 13,000 g, and the supernatant was removed and discarded. Following this, the polystyrene particles were resuspended in sterile distilled water. Thereafter, the centrifugation and resuspension of the polystyrene particles was repeated twice more to rinse the polystyrene particles. The volume polystyrene particles were then suspended in 0.5 mL of sterile distilled water.

### Example 2

Obtaining the Microorganisms

The microorganisms obtained were Escherichia coli (abbreviated “E. coli,” ATCC 13706), Staphylococcus epidermidis (abbreviated “S. epidermidis,” ATCC 12228), Bacillus atrophaeus (abbreviated “B. atrophaeus,” ATCC 9372), Micrococcus lylae (abbreviated “M. lylae,” ATCC 27566), Corynebacterium afermentans (abbreviated “C. afermentans,” ATCC 51403), and Aspergillus niger (abbreviated “A. niger,” ATCC 9142). Note that ATCC is an abbreviation for the “American Type Culture Collection.”

(Lou, generally, article, for instance “the”, isn't used to express name of microbes. Then, please delete articles to any relevant expression in this draft.) E. coli is a Gram-negative bacterium. Staphylococcus epidermidis, Bacillus atrophaeus, Micrococcus lylae, and Corynebacterium afermentans are Gram-positive bacteria. A. niger is also known as black aspergillus, and is a type of mold spore.

Method for Preparing the Microorganisms

E. coli, S. epidermidis, and M. lylae were inoculated into 3 mL each of a tryptic soy broth (Becton, Dickinson and Company, Ref: 211825), and left overnight at 32° C., to be cultured aerobically. When further culturing E. coli, S. epidermidis, and M. lylae on an agar medium, emulsions of the bacteria were streaked onto a tryptic soy agar medium (Eiken Chemical Company, Ltd.: E-MP25), and left overnight at 32° C. to be cultured aerobically.

When culturing C. afermentans, an R medium (10 g peptone, 5 g yeast extract, 5 g malt extract, 5 g casamino acid, 2 g beef extract, 2 g glycerin, 50 mg Tween 80, 1 g MgSO₄.7H₂O, and 1 L distilled water, pH7.2) was used as the liquid culture medium, and a sheep blood agar was used as the agar.

When preparing the microorganisms from the liquid culture medium, a centrifuge (Kubota Trading Company: 2410 or Hitachi Koki: CT13R) was used for three minutes at 2100 g to collect the bacteria from the culture solution, and then, after removing and discarding the supernatant medium, the microorganisms were resuspended in sterile distilled water. Thereafter, the centrifugation and resuspension of the microorganisms was repeated twice more to rinse the microorganisms. The microorganisms were suspended in 3 mL of distilled water.

When preparing the microorganisms from the agar, colonies were scraped off of the agar and suspended in 5 mL of sterile distilled water. Following this, after lightly vortexing the suspension to disperse the microorganisms, the microorganisms were collected by centrifuging the suspension for three minutes at 2100 g and removing and discarding the supernatant, to produce the clean microorganisms. Thereafter, the microorganisms were resuspended in 5 mL of sterile distilled water.

For B. atrophaeus, a commercially available spore solution (North American Science Associates, Inc.: SUN-07) was used.

For tA. niger, culturing was performed on a potato dextrose agar (Ai Science Laboratory: PM0002-1). aA. niger that had been stored at 4° C. was injected, using a needle, into the medium and cultured for one week at 25° C. to produce spores. Following this, approximately 10 mL of an aqueous solution of 50 mg/L of dioctyl sodium sulfosuccinate was poured onto the culture plate where on the spores were formed, and the spores were gently scratched off using a disposable loop and dispersed into the aqueous solution. The aqueous solution into which the spores were dispersed was collected using a pipette, and after removing the fungal filaments by passing the aqueous solution through an 8-ply sterile gauze, the filtrate was centrifuged for ten minutes at 1400 g, and the supernatant was removed. 10 mL of sterile distilled water was added to the precipitated spores, and after rinsing, centrifugation was performed again under the same conditions. After repeating this three times, the spores were suspended in 5 mL of sterile distilled water, to produce a spore fluid.

### Example 3

Measuring the Fluorescence Intensity Using a Fluorescent Microscope Under Dry Conditions

A drop of the polystyrene particle suspension or microorganism suspension was placed onto a glass slide, dried in a dark location, and then examined under a fluorescent microscope (Olympus Corp.: Model BX51). For excitation by light in the vicinity of the 340 nm wavelength, the U-MWU2 mirror unit was used, and for excitation by light in the vicinity of the 405 nm wavelength, the U-MNV2 mirror unit was used. The polystyrene particles or microorganisms were observed using an UMPlanFL×100 objective lens, without covering the glass slide with a cover glass. The stray light from the dark field optical path was cut using the DIC slider. A fluorescent image of the polystyrene particles or microorganisms and a brightfield image of the same field of view were captured using a DP-70 CCD camera (Olympus Corp.) connected to the microscope.

The fluorescent image that was taken was converted into an 8-bit grayscale image using Image-Pro+6.3 J (Media Cybernetics, Inc.) image analyzing software to detect the polystyrene particles or microorganisms in the fluorescent image. The per-polystyrene-particle fluorescence intensity was calculated by summing the grayscale values of the pixels in a range identified as a particle by the image analyzing software. At this time, the average grayscale value of pixels in an arbitrary range containing no particles within the image was calculated and defined as the background value, where this background value was subtracted from the grayscale values of the respective pixels within the range identified as a particle to correct the per-polystyrene-particle fluorescence intensity. If an aggregation of a plurality of polystyrene particles was identified as a single particle, then, based on the brightfield image, the number of particles therein was evaluated, and the fluorescence intensity of the aggregation of particles was divided by the number of particles to calculate the average per-polystyrene-particle fluorescence intensity. The per-microorganism fluorescence intensity was also calculated using the same technique.

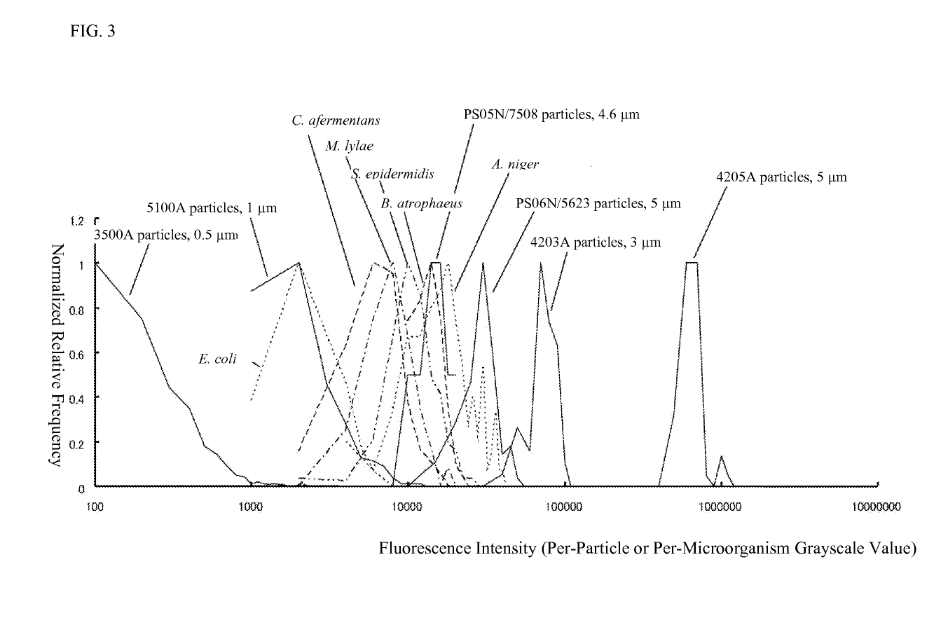

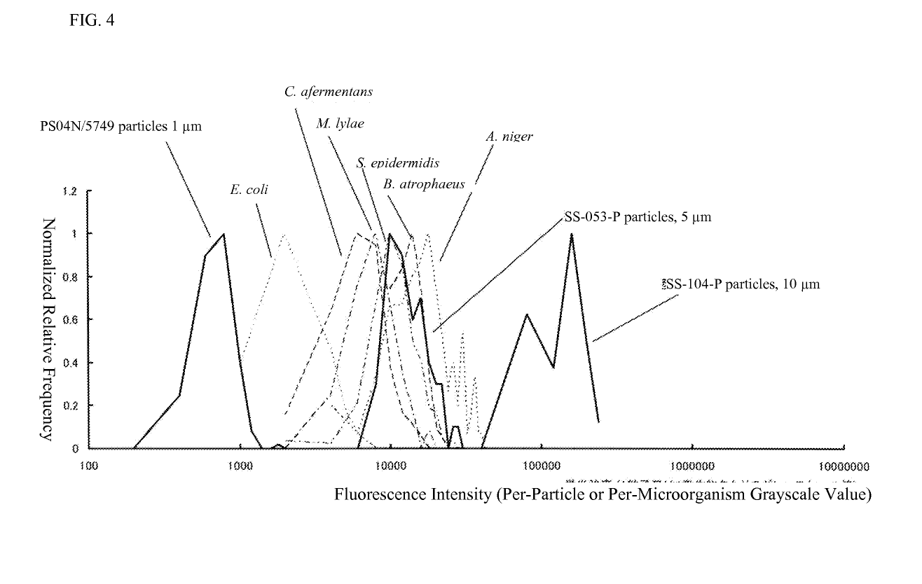

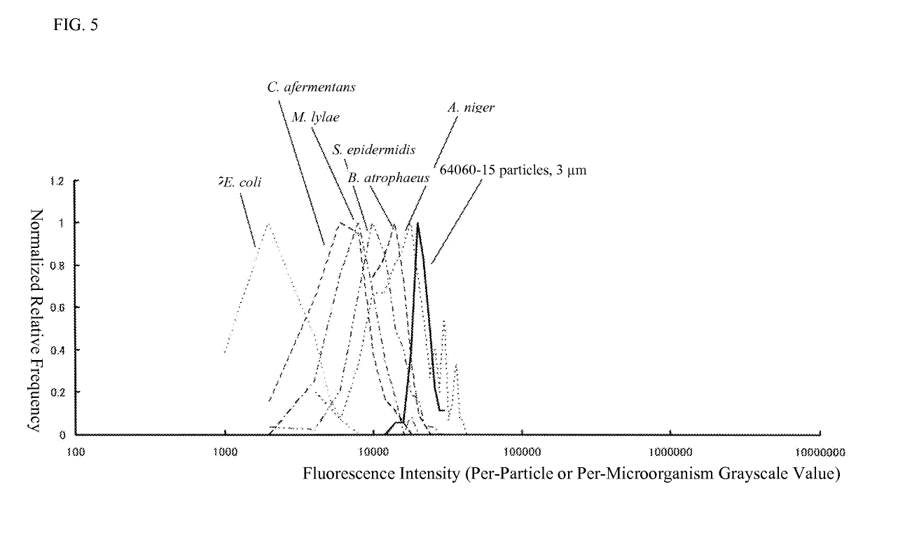

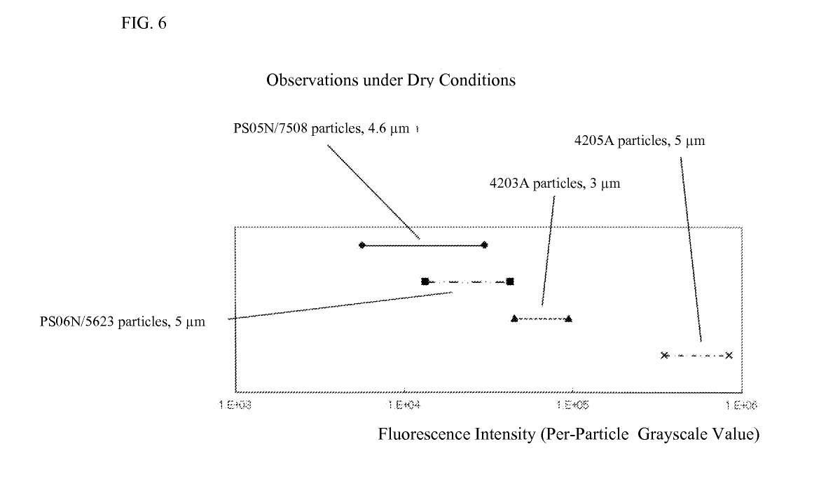

In the case of using excitation light in the vicinity of a 405 nm wavelength, the distribution of fluorescence intensities of the polystyrene particles and of the microorganisms were as shown in FIG. 3, FIG. 4, and FIG. 5. FIG. 6 is a graph showing the 95% confidence intervals calculated for fluorescence intensities for polystyrene particles of product no. PS05N/7508, product no. 4203A, and product no. 4205A. As shown in FIG. 3, FIG. 4, and FIG. 5 the product no. 5100A particles, the product no. 4203A particles, the product no. PS04N/5749 particles, the product no. PS06N/5623 particles, the product no. PS05N/7508 particles, the product no. SS-053-P particles, and the product no. 64060-15 particles produced fluorescence with intensities similar to those of the microorganisms. The intensity of the fluorescence produced by the product no. 5100A particles was close to the intensity of the fluorescence produced by C. afermentans, M. lylae, and E. coli. The intensity of the fluorescence produced by the product no. PS04N/5749 particles was close to the intensity of the fluorescence produced by E. coli. The intensity of the fluorescence produced by the product no. PS05N/7508 particles was close to the intensity of the fluorescence produced by C. afermentans, M. lylae, S. epidermidis, B. atrophaeus, and A. niger. The intensities of the fluorescence produced by the product no. PS06N/5623 particles and the product no. 4203A particles were near to the intensities of the fluorescence produced, respectively, by B. atrophaeus and A. niger. The intensity of the fluorescence produced by the product no. SS-053-P particles was close to the intensity of the fluorescence produced by C. afermentans, M. lylae, S. epidermidis, B. atrophaeus, and A. niger. The intensity of the fluorescence produced by the product no. 64060-15 particles was close to the intensity of the fluorescence produced by A. niger.

The intensity of the fluorescence produced by the product no. 3500A particles was weaker than the intensity of the fluorescence produced by the microorganisms. The intensity of the fluorescence produced by the product no. SS-104-P particles was somewhat stronger than the intensity of the fluorescence produced by the microorganisms. The intensity of the fluorescence produced by the product no. 4205A particles was stronger than the intensity of the fluorescence produced by the microorganisms.

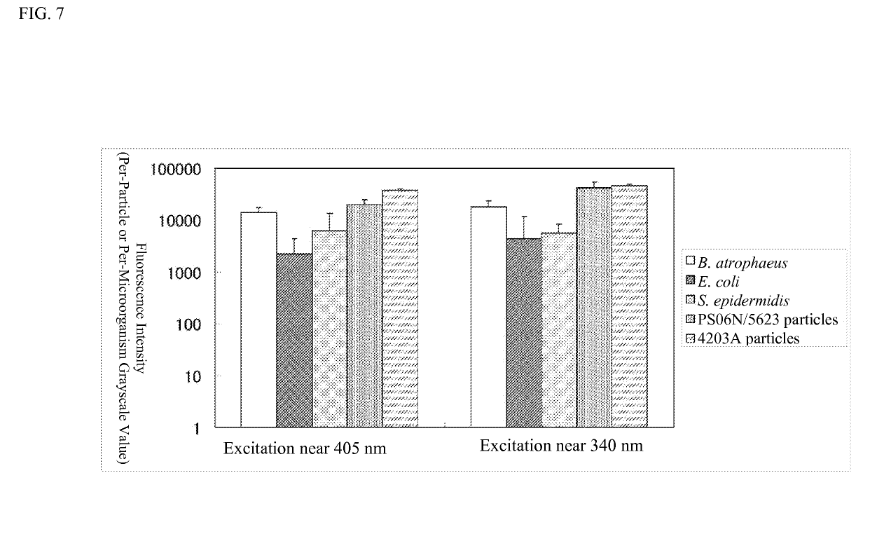

Moreover, when an excitation light in the neighborhood of a 405 nm wavelength and an excitation light in the neighborhood of a 340 nm wavelength were each separately used, the distributions of the fluorescence intensities of the polystyrene particles and the microorganisms were as shown in FIG. 7. As shown in FIG. 7, there were no remarkable changes in the intensities of fluorescence produced by the respective polystyrene particles or microorganisms even when the wavelength of the excitation light was changed.

### Example 4

Measuring the Fluorescence Intensity Using a Fluorescent Microscope Under In-Suspension Conditions

A drop of the suspension of polystyrene particles (product no. PS05N/7508, product no. PS06N/5623, product no. 4203A, or product no. 4205A) was placed onto a glass slide and covered with a cover glass, and then examined under a fluorescent microscope (Olympus Corp.: Model BX51) without being allowed to dry. The U-MNV2 mirror unit was used for excitation by light in the vicinity of the 405 nm wavelength. The polystyrene particles were observed using an UMPlanFL×100 objective lens, with the cover glass in place. The stray light from the dark field optical path was cut using the DIC slider. A fluorescent image of the polystyrene particles and a bright field image of the same field of view were captured using a DP-70 CCD camera (Olympus Corp.) connected to the microscope.

The fluorescent image that was taken was converted into an 8-bit grayscale image using Image-Pro+6.3 J (Media Cybernetics, Inc.) image analyzing software to detect the polystyrene particles in the fluorescent image. The per-polystyrene-particle fluorescence intensity was calculated by summing the grayscale values of the pixels in a range identified as a particle by the image analyzing software. At this time, the average grayscale value of pixels in an arbitrary range containing no particles within the image was calculated and defined as the background value, where this background value was subtracted from the grayscale values of the respective pixels within the range identified as a particle to correct the per-polystyrene-particle fluorescence intensity. If an aggregation of a plurality of polystyrene particles was identified as a single particle, then, based on the bright field image, the number of particles therein was evaluated, and the fluorescence intensity of the aggregation of particles was divided by the number of particles to calculate the average per-polystyrene-particle fluorescence intensity.

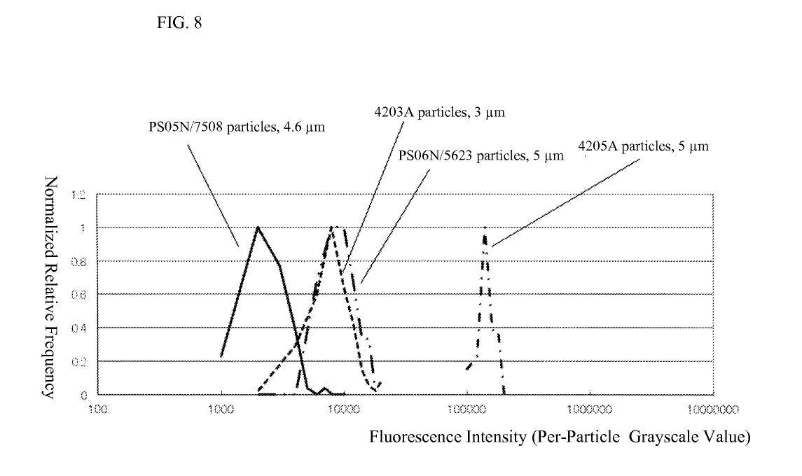

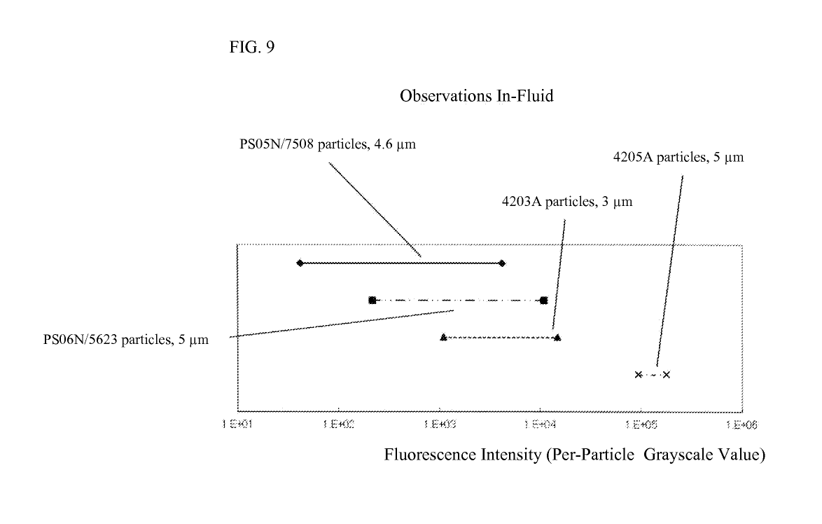

In the case of using excitation light in the vicinity of a 405 nm wavelength, the distribution of fluorescence intensities of the polystyrene particles was as shown in FIG. 8. FIG. 9 is a graph of the 95% confidence intervals calculated for the distributions of the fluorescence intensities. When observed in-fluid, the intensities of the fluorescence produced by the polystyrene particles, as a whole, are lower when compared to those under dry conditions. However, the magnitude relationships of the fluorescence intensities as a function of the type of particle are essentially the same whether under dry conditions or under in-fluid conditions. For example, as shown in FIG. 6, under dry conditions there is a tendency for there to be increasing fluorescence intensity in the following sequence: product no. PS05N/7508 particles, product no. PS06N/5623 particles, product no. 4203A particles, and product no. 4205A particles. In this regard, as shown in FIG. 9, in-fluid as well, there is a tendency for there to be increasing fluorescence intensity in the following sequence: product no. PS05N/7508 particles, product no. PS06N/5623 particles, product no. 4203A particles, and product no. 4205A particles. When observed in-fluid, the intensities of the fluorescence produced by the microorganisms particles, as a whole, are also lower when compared to those under dry conditions. Consequently, the fluorescence intensities of the polystyrene particles are near to the fluorescence intensities of the microorganisms, even in the suspension.

### Example 5

Measuring the Fluorescence Intensity Using the Microorganism Detecting Apparatus

The measurement of the fluorescence intensity by the microorganism detecting apparatus was according to the Journal of Aerosol Science, Vol. 42, 397-407, 2011). That is, the air within a chamber was cleaned by way of a HEPA filter unit in a closed chamber with a volume of 3 m³ provided with a HEPA filter unit. Thereafter, a suspension of either polystyrene particles or microorganisms was sprayed for 20 seconds with a flow rate of 5 L/minute using a nebulizer (Salter Labs, Inc.: REF8900) to produce a suspension within the air in the chamber. Thereafter, the air within the chamber was agitated for 30 seconds, both to dry any water droplets and to uniformly disperse the polystyrene particles or microorganisms. Thereafter, the air within the chamber was measured, using an airborne microbe detector (Azbil BioVigilant Inc.: IMD-A300) as the microorganism detecting apparatus, for 60 seconds, to detect the polystyrene particles or microorganisms in the air. The fluorescence intensities detected for the polystyrene particles or microorganisms were obtained as detection voltage values for the fluorescence detector of the airborne microbe detector.

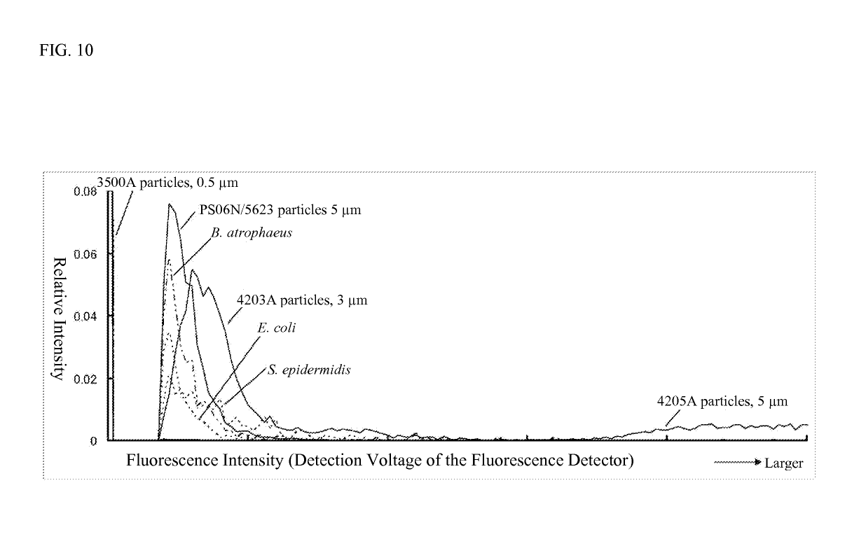

The distributions of the fluorescence intensities for the polystyrene particles and the microorganisms, measured by the airborne microbe detector, were as shown in FIG. 10. Even when measured by the airborne microbe detector, the fluorescence intensities of the polystyrene particles were found to be near to the fluorescence intensities of the microorganisms.

We claim:

1. A method for calibrating a microorganism detecting apparatus comprising the steps of:
drawing into the microorganism detecting apparatus a polystyrene particle that, when exposed to light, produces a fluorescence of an intensity that is essentially identical to an intensity of fluorescence produced by a microorganism;
exposing the polystyrene particle to a light from a light source of the microorganism detecting apparatus and detecting, with a fluorescence detector of the microorganism detecting apparatus, the fluorescence produced by a polystyrene particle; and
calibrating the microorganism detecting apparatus based on a detected intensity of the fluorescence.

2. The method for calibrating a microorganism detecting apparatus as set forth in claim 1, wherein:
the polystyrene particle essentially is made from polystyrene.

3. The method for calibrating a microorganism detecting apparatus as set forth in claim 1, wherein:
the polystyrene particle essentially is made from polystyrene and divinylbenzene.

4. The method for calibrating a microorganism detecting apparatus as set forth in claim 1, wherein:
the polystyrene particle essentially is made from 98% by mass polystyrene and 2% by mass divinylbenzene.

5. The method for calibrating a microorganism detecting apparatus as set forth in claim 2, wherein:
the diameter of the polystyrene particle is no less than 0.75 μm and less than 10 μm.

6. The method for calibrating a microorganism detecting apparatus as set forth in claim 3, wherein:
the diameter of the polystyrene particle is no less than 0.75 μm and no more than 7.5 μm.

7. The method for calibrating a microorganism detecting apparatus as set forth in claim 1, wherein:
the light is visible light.

8. The method for calibrating a microorganism detecting apparatus as set forth in claim 1, wherein:
the light has a wavelength between 400 and 410 nm.

9. The method for calibrating a microorganism detecting apparatus as set forth in claim 1, wherein:
the light is ultraviolet radiation.

10. The method for calibrating a microorganism detecting apparatus as set forth in claim 1, wherein:
the light has a wavelength between 310 and 380 nm.

11. The method for calibrating a microorganism detecting apparatus as set forth in claim 1, wherein:
wherein the microorganism includes a bacterium.

12. The method for calibrating a microorganism detecting apparatus as set forth in claim 11, wherein:
the bacterium includes one or more selections from a Gram-negative bacterium such as Escherichia coli, a Gram-positive bacteria such as Staphylococcus epidermidis, Bacillus atrophaeus, Micrococcus lylae, and Corynebacterium afermentans, and a fungus such as a mold spore.

13. The method for calibrating a microorganism detecting apparatus as set forth in claim 1, wherein:
in the exposure of the polystyrene particle to light from a light source of the microorganism detecting apparatus, the polystyrene particle is dry.

14. The method for calibrating a microorganism detecting apparatus as set forth in claim 1, wherein:
in the exposure of the polystyrene particle to light from a light source of the microorganism detecting apparatus, the polystyrene particle is in a fluid.

15. A kit for calibrating a microorganism detecting apparatus, comprising:
a polystyrene particle that, when exposed to light, produces fluorescence of an intensity essentially equal to the intensity of fluorescence produced by a microorganism.

16. The kit for calibrating a microorganism detecting apparatus as set forth in claim 15, wherein:
the polystyrene particle essentially is made from polystyrene.

17. The kit for calibrating a microorganism detecting apparatus as set forth in claim 15, wherein:
the polystyrene particle essentially is made from polystyrene and divinylbenzene.

18. The kit for calibrating a microorganism detecting apparatus as set forth in claim 15, wherein:
the polystyrene particle essentially is made from 98% by mass polystyrene and 2% by mass divinylbenzene.

19. The kit for calibrating a microorganism detecting apparatus as set forth in claim 16, wherein:
the diameter of the polystyrene particle is no less than 0.75 μm and less than 10 μm.

20. The kit for calibrating a microorganism detecting apparatus as set forth in claim 17, wherein:
the diameter of the polystyrene particle is no less than 0.75 μm and no more than 7.5 μm.

21. The kit for calibrating a microorganism detecting apparatus as set forth in claim 15, wherein:
the light is visible light.

22. The kit for calibrating a microorganism detecting apparatus as set forth in claim 15, wherein:
the light has a wavelength between 405 and 410 nm.

23. The kit for calibrating a microorganism detecting apparatus as set forth in claim 15, wherein:
the light is ultraviolet radiation.

24. The kit for calibrating a microorganism detecting apparatus as set forth in claim 15, wherein:
the light has a wavelength between 310 and 380 nm.

25. The kit for calibrating a microorganism detecting apparatus as set forth in claim 15, wherein:
wherein the microorganism includes a bacterium.

26. The kit for calibrating a microorganism detecting apparatus as set forth in claim 25, wherein:
the bacterium includes one or more selections from a Gram-negative bacterium such as Escherichia coli, a Gram-positive bacteria such as Staphylococcus epidermidis, Bacillus atrophaeus, Micrococcus lylae, and Corynebacterium afermentans, and a fungus such as a mold spore.

27. The kit for calibrating a microorganism detecting apparatus as set forth in claim 15, wherein:
the polystyrene particle, when exposed to light in a state wherein it is dry, produces fluorescence of an intensity essentially equal to the intensity of fluorescence produced by a microorganism when in a state wherein it is dry.

28. The kit for calibrating a microorganism detecting apparatus as set forth in claim 15, wherein:
the polystyrene particle, when exposed to light when in a fluid, produces fluorescence of an intensity essentially equal to the intensity of fluorescence produced by a microorganism when in a state when in a fluid.
